(19) United States
(12) Patent Application Publication
(10) Pub. No.: US 2015/0298033 A1
(43) Pub. Date: Oct. 22, 2015

(54) FUEL FILTER ADAPTER PLATE

(71) Applicant: Hatton Marine and Industrial Repair, Inc., Seattle, WA (US)

(72) Inventor: Dustin Jones, Seattle, WA (US)

(73) Assignee: Hatton Marine and Industrial Repair, Inc., Seattle, WA (US)

(21) Appl. No.: 14/257,764

(22) Filed: Apr. 21, 2014

(51) Int. Cl. B01D 35/00

(52) U.S. Cl. CPC B01D 35/005

(57) ABSTRACT

An adapter plate allows mating a spin-on cartridge filter to a Wm. W. Nugent & Company™ compact filter base and bracket assembly. A medial channel is configured to receive a medial O-ring and the peripheral channel is configured to receive a peripheral O-ring. The first face further defines four threaded bolt holes spaced apart to received four bolts extending from the compact filter base and when rotated in a clockwise direction draw the medial O-ring in the medial channel into sealing contact with an aperture boss extending from the base. and the peripheral O-ring in the peripheral channel into sealing contact with a shoulder extending from the base such that there is formed a manifold sealed by the cooperation of the medial O-ring in the medial channel contacting the aperture boss and the perimeter O-ring in the perimeter channel contacting the shoulder.

### FIELD OF THE INVENTION

The adapter plate relies upon filtration technology, more specifically machined fittings to conduct a flow of liquid through a spin-on filter.

### BACKGROUND OF THE INVENTION

On Oct. 16, 1962, Corliss D. Nugent and his employer, Wm. W. Nugent & Company™ received U.S. Pat. No. 3,058,592 for a Liquid Filter. Heralded as a breakthrough at the time, the invention included several improvements in filtration technology, particularly the replaceable filtration media cartridge held within a formed vessel or housing that could be readily opened to change the cartridge. As shown as prior art in FIG. 1, and as described in the '592 patent, a metal housing or can 1 is closed at its lower end, the lower end being flat as at 2. The upper end of the can is outwardly flanged about its entire outer periphery at 3. A yoke 4 encircles the upper end of the can and supports the flange 3. A packing washer 5 is interposed between the flange 3 and the fixed base 6. Screws 7 threaded in the yoke 4 pass through the base 6 and may be tightened to clamp and rigidly hold the can 1 in position, compressing the packing ring 5 so that there will be no leakage about the upper end of the can.

The Nugent™ filter has proven to be an extraordinarily useful appliance for filtration and its dominance in the market has continued well after the expiration of the patent. One reason for the popularity of the Nugent™ filter is the utility of the bracket used for support of the entire filter. A bracket 8 supports the base 6 in fixed position through the bolt holes 9, the bolts not being shown. Because the bracket 8 is integral with the base 6, the filter is able to be mounted, advantageously, to any vertical surface in proximity to the rest of the fuel system feeding and engine including on the exterior of the engine itself. As such, this bracket 8 and base 6 being formed as a monolith has assured the utility of the Nugent™ filter.

For over a half a century, this fuel filter has been used to great advantage especially in the marine locomotion and other “big-plant” industrial settings. The Nugent™ Compact Filter and Strainer has so dominated this market that even the profile of the housing is readily recognized by mechanics well-schooled in servicing industrial installations.

The Nugent™ Compact Filter has broad tolerances given the large surface area of the compact filter cartridge, typically ranging to include flows to 50 gpm and design pressures to 200 PSI. The simplex is composed of one drawn carbon steel housing secured to a cast iron cover with four heavy-duty bolts. When constructed, a housing contains one filter element or strainer basket. The duplex incorporates two such drawn carbon steel housings, each housing containing one filter element or strainer basket suspended from a common cast iron bracket. The shells are interconnected by a Nugent dual-circuit transfer valve directing continuous flow to either shell independently or to both in parallel.

But the Nugent™ system is not without its drawbacks. Relying as it does on a rigid tubular filter cartridge 19, the cartridge must be urged into sealing engagement with the lower surface of the base 6. On the under face of the base 6 is the central aperture boss 13 in register with the boss 11 and having a conical bearing surface 14. Encircling this bearing surface is an annular screen 15 held on the boss 13 by the screws 16 and conventional lock washers and resting on shoulders 17 about its outer periphery so as to define an exhaust manifold 18 communicating with the exhaust opening 12. To achieve this sealing engagement, the tubular filter cartridge 19 is pressed upward with substantial pressure by a spring 21.

The problem with such a configuration is this very pressure the spring 21 exerts upon the filter cartridge is also equally exerted against the inside of the can 2 urging it away from the base. Being held, as it is, with four bolts 7 which must be tightened against the biasing coil spring 21 in order to close the can 2 into sealing engagement with the base 6. Until properly secured, the filter housing can 2 and base 6 wants to spring apart in the mechanic's hands. Not only are the bolts 7 torqued against the biasing force of the coil spring 21, but each must be progressively torqued in turn against a resilient gasket 5 in order to assure that the gasket 5 is evenly compressed without internal stresses such that no leaks will occur.

Mechanics must often perform these torquing actions in tightly constrained areas in close proximity to the engine or on the engine itself and generally allowing very little room to swing a wrench. Unfortunately, this is not an easy task to perform and because of that, where the mechanic is given the discretion, they tend to put off the task resulting in extended maintenance intervals with the possible result of undue wear to fuel injectors or carburetor jets as fuel carries abrasive debris through orifices to admit fuel into a combustion chamber.

Additionally, filter media have improved greatly in the last half century. For example, new filter media exist with capabilities beyond those of the cloth and paper bag that was the subject of the Nugent patent. For example, microporous membranes and other such materials exist that were not available at the time of the filing of the Nugent patent are commonly available in spin on cartridge filters. Additionally, the reuse of filter housings such as the Nugent™ filter has proven, itself, to be an opportunity for incursion of ambient dust and debris as well as previously separated debris that may also be resident in the reused housing, thus infiltrating the fuel delivery system, bypassing the filter media each time the housing is opened.

In the mid-1950s, the spin on filter design was introduced: a self-contained housing and element assembly which was to be unscrewed from its mount, discarded, and replaced with a new one. Unfortunately, the replacement of a Nugent™ Compact Filter installation in an existing fuel system to convert to a spin on-type of filter system often requires the replacement of metal lines leading to and from the filter housing and, the event itself, can be an opportunity for incursion by dust and debris. Additionally, the Nugent™ filter is configured such that its housing is mounted directly to a firewall or other support, or even the engine itself, and these mounting sites have little additional room. To locate a new fuel system with a new filter housing might necessitate even the removal of the engine. What is needed is a method to exploit the advancements in filtration available in late model spin on filters without removing that portion of the installed Nugent™ Compact Filter Housing affixed to the mounting point.

### SUMMARY OF THE INVENTION

An adapter plate allows mating a spin-on cartridge filter to a Wm. W. Nugent & Company™ compact filter base and bracket assembly. A medial channel is configured to receive a medial O-ring and the peripheral channel is configured to receive a peripheral O-ring. The first face further defines four threaded bolt holes spaced apart to received four bolts extending from the compact filter base and when rotated in a clockwise direction draw the medial O-ring in the medial channel into sealing contact with an aperture boss extending from the base, and the peripheral O-ring in the peripheral channel into sealing contact with a shoulder extending from the base such that there is formed a manifold sealed by the cooperation of the medial O-ring in the medial channel contacting the aperture boss and the perimeter O-ring in the perimeter channel contacting the shoulder.

The nipple has a threaded circumferential section to receive the spin-on cartridge filter, the dimensions of the nipple and the threaded circumferential section being selected to mate with the cartridge filter in a manner that facilitates suitable flow of liquid through the cartridge filter. The nipple defines an intake orifice through the adapter plate in order to admit a flow of liquid from the first face within the medial O-ring into the cartridge filter. An exhaust orifice the adapter defines to allow a liquid flow from within the cartridge filter to the manifold.

### BRIEF DESCRIPTION OF THE DRAWINGS

Preferred and alternative examples of the present invention are described in detail below with reference to the following drawings:

FIG. 1 is an illustration of a prior art patent granted to Corliss D. Nugent and assigned to Wm. Nugent and Company, referred to herein as the “Nugent Filter;”

FIG. 2 is an orthogonal view of an adapter plate to mate with the Nugent filter;

FIG. 3 is a plan view of the adapter plate showing a first face;

FIG. 4 is an off-axis view of the adapter plate showing a second face and a spin-on nipple;

FIG. 5 is a plan view of the adapter plate showing the second face and the spin-on nipple; and

FIG. 6 is an in situ view of the adapter plate supporting a spin-in filter adjacent to a stock Nugent Filter for comparison.

### DETAILED DESCRIPTION OF THE PREFERRED EMBODIMENT

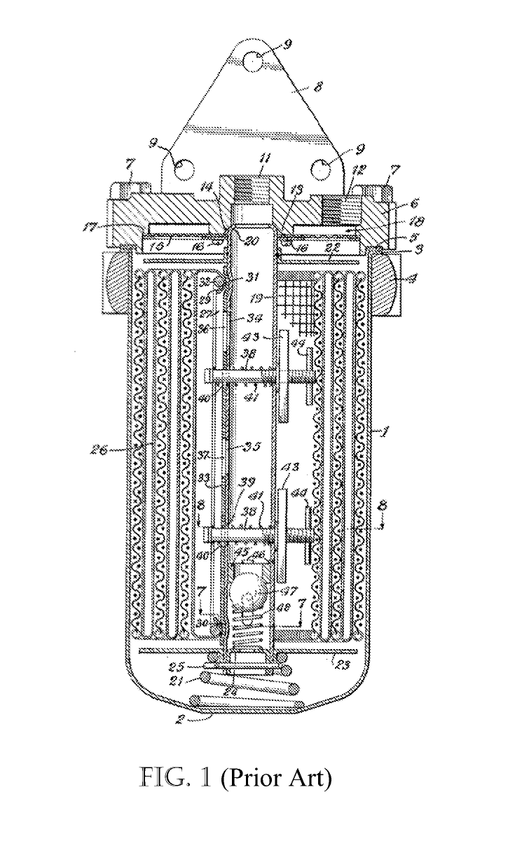

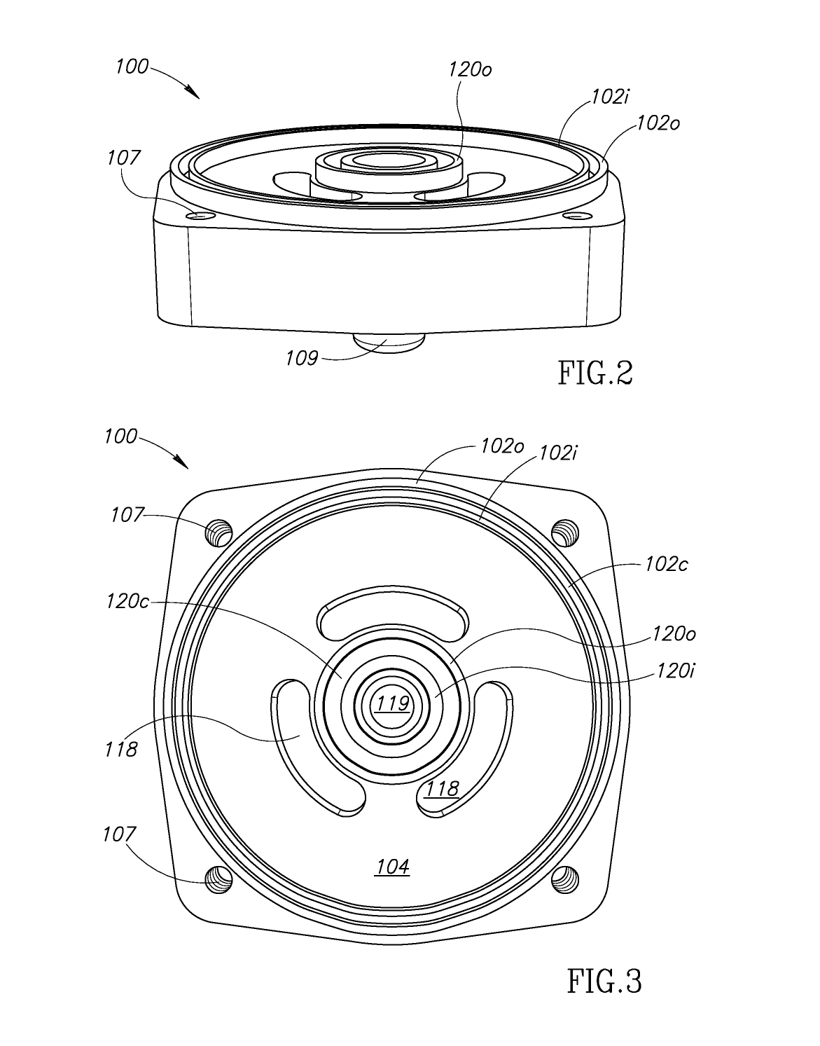

Referring to FIGS. 1 and 2, an adapter plate 100 is configured such that four bolts 7 draw the plate into engagement with a base 6 after removing a can 2 and filter assembly the can 2 contains. The bolts 7 are rotated into threaded engagement with bolt holes 107 the plate defines, the bolt holes 7 being spaced apart to match the bolts 7 as they pass through the base 6.

Referring to FIGS. 2 and 3, there are defined on the a face 104 of the plate 100, are two channels: a medial channel 120c defined by an inner medial shoulder 102i and an outer medial shoulder 102o; and a perimeter channel 102c defined by an inner perimeter channel 102i and an outer perimeter channel 102o. Each of the medial channel 120c and the perimeter channel 102c are formed to receive a resilient O-ring (neither are shown), the O-rings to serve as seals preventing the intermixing of intake and exhaust fluids. When drawn into contact with the base 6, the medial O-Ring (not shown) in the medial channel 120c contacts the aperture boss 13 (FIG. 1) to form a medial seal; and the perimeter O-ring (not shown) resting in the perimeter channel 102c contacts the shoulder 17 (FIG. 1) to form a perimeter seal.

Two sets of orifices exist to provide intake and exhaust paths for the fuel. A nipple 109 defines an intake orifice 119 which admits unfiltered fuel through the plate 100 and into a spin on filter (not shown). The remaining orifices, three exhaust orifices 118, admit the filtered fuel back through the plate in the opposite direction, flowing into the manifold 18 (FIG. 1) defined by the face 104 in opposed relation to the base 6 and bounded by the shoulder 17 on the outer edge and the aperture boss 13 on the inner edge. The manifold 18 is sealed by the cooperation of the medial O-ring in the medial channel 120c contacting the aperture boss 13 (FIG. 1) and the perimeter O-ring in the perimeter channel 102c contacting the shoulder 17 (FIG. 1).

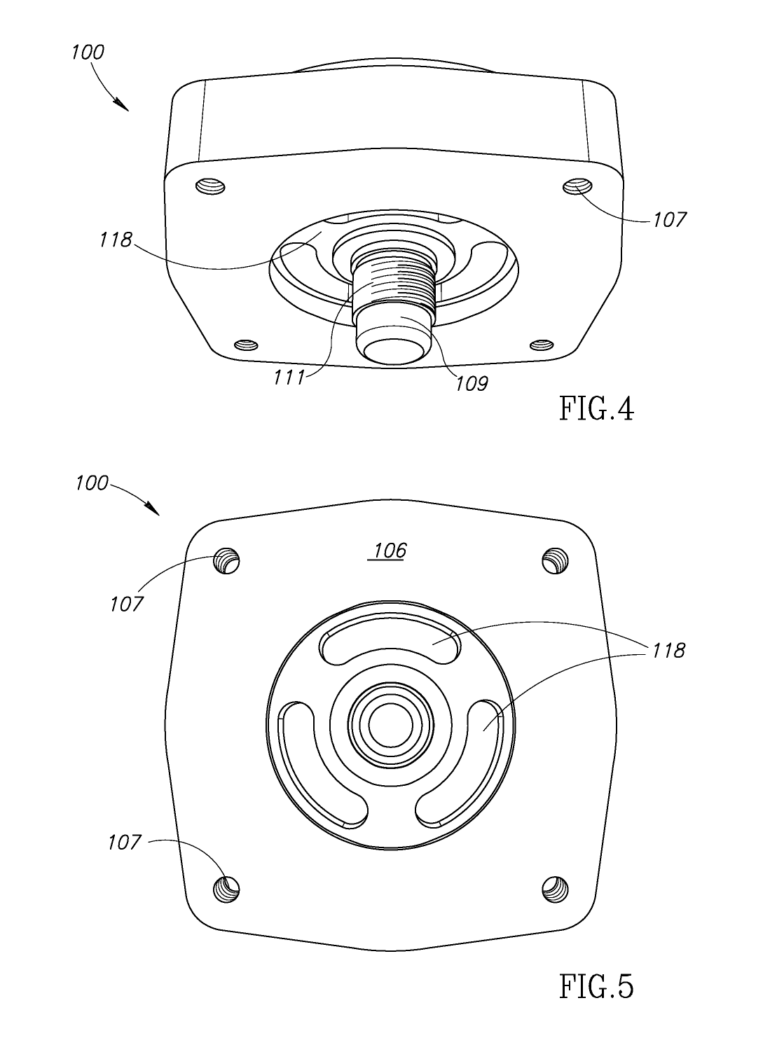

FIGS. 4 and 5 depict an opposite face 106 of the adapter plate 100 spaced apart from and parallel to the first face 104 (FIG. 3). Clearly visible are the threaded bolt holes 107 and the exhaust orifices 118. In at least one embodiment of the invention, however, there is no need for the bolt holes 107 to extend through the plate 100 and emerge at the opposite face 106. Nonetheless, the preferred embodiment is here depicted and the bolt holes 107 extend to the opposite face, thereby providing a path for any debris that might accumulate in the bolt hole 107 to fall out without impeding the progress of the bolts 7 through the bolt holes 107.

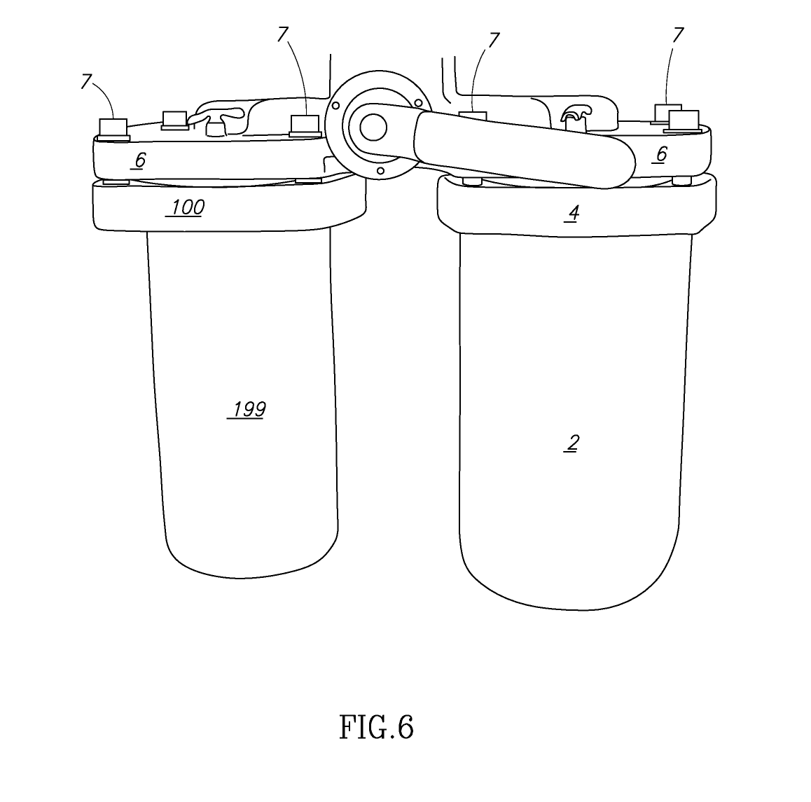

A nipple 109 having a threaded circumferential section 111 are selected based upon the intended spin on filter cartridge to be attached (not pictured.) The preferred length and outer diameter for the nipple 109 and its threaded circumferential section 111 is selected in accord with the availability and demands of the application. For example, the spin on filter associated with engines in American Hoist & Derrick, Demag, Dresser, Komatsu, Terex Equipment, and Detroit Diesel Engines is the Baldwin™ Filter BF 785 shown in FIG. 6. For that application, the nipple 109 and the circumferential threaded section 111 will have a 1 1/16″ diameter and a thread pitch of 16 threads per inch. The following table indicates a number of other common sizes for fuel filters for diesel engine applications, wherein the nipple 109 and the threaded circumferential section would be selected as described:

| | | | MEDIA | |
|---|---|---|---|---|
| HEIGHT | | | TYPE | |
| inches/mm | | THREAD | RATING | Comman Application |
| 6.85*/174 | mm | 13/16-12 UN-2B | 10 micron | Detroit diesel 23518530, AC TP916D |
| | | | | Secondary Filter |
| 10.16*/258 | mm | 1-14 UNS-2B | 10 micron | Cat 4N-5823 |
| | | | | Primary Filter |
| 9.69* 246 | mm | 1-14 UNS-2B | 5 micron | Cummins, Freightliner |
| | | | water | Fuel/Water Separator |
| | | | separator | |
| 8.19*/208 | mm | 1-12 UNF-2B | 30 micron | Detroit diesel 23517471, AC T915D |
| | | | | Primary Filter |
| 3.94*/100 | mm | M16 × 1.5 | 10 micron | Ford Cargo Truck E67HZ9365A, |
| | | | | Deutz, Kabota |
| | | | | Primary Filter |
| 4.84*/123 | mm | M16 × 1.5 | 10 micron | Case Tractors, Deutz, Volvo 243004 |
| | | | | Cummins 6C, 6CT |
| | | | | Secondary Filter |
| 5.32*/135 | mm | 1-14 UNS-2B | 10 micron | Cummins 154709, Ford GM Kenworth, |
| | | | | Dodge, Hino Trucks |
| | | | | Secondary Filter |
| 8.23*/209 | mm | 1-14 UNS-2B | 30 micron | Case 625627C1, IHC/Navistar |
| | | | | Primary Filter |

FIG. 6 depicts the adapter plate 100 bolted to the base 6 in sealing engagement by four bolts 7. A Baldwin™ spin on filter 199. is suitably torqued onto the nipple 109 by its threaded circumferential section 111 (not visible) to provide filtration to a flow of fuel through the filter 199. By comparison, the standard Nugent™ filter can 2 affixed to the base 6 by four bolts 7 threaded into a collar 4 is also shown. Interestingly, the total filter surface contained in the filter 199 is far greater than that of the Nugent™ filter assuring far greater filter efficiency. Given the media type rating of the Baldwin™ filter, the adapter plate 100 and filter 199 ought to yield superior performance increasing the life of the fuel injectors.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An adapter plate for mating a spin-on cartridge filter to a Wm. W. Nugent & Company™ compact filter base and bracket assembly, the adapter plate comprising:
a first face:
the first face defining a medial channel and a peripheral channel, each of the medial channel configured to receive a medial O-ring and the peripheral channel configured to receive a peripheral O-ring;
the first face further defining four bolt holes spaced apart to received four bolts extending from the compact filter base to draw the medial O-ring in the medial channel into sealing contact with an aperture boss extending from the base; and the peripheral O-ring in the peripheral channel into sealing contact with a shoulder extending from the base such that there is formed a manifold sealed by the cooperation of the medial O-ring in the medial channel contacting the aperture boss and the perimeter O-ring in the perimeter channel contacting the shoulder; and
a second face spaced apart from the first face:
the second face from which a nipple extends comprises:
the nipple having a threaded circumferential section to receive the spin-on cartridge filter, the dimensions of the nipple and the threaded circumferential section being selected to mate with the cartridge filter in a manner that facilitates suitable flow of liquid through the cartridge filter;
the nipple defining an intake orifice through the adapter plate in order to admit a flow of liquid from the first face within the medial O-ring into the cartridge filter; and
a exhaust orifice the adapter defines to allow a liquid flow from within the cartridge filter to the manifold.

2. The adapter plate of claim 1, further comprising a spin-on filter cartridge defining a threaded orifice, the threaded orifice having a diameter and thread pitch corresponding to the diameter and the thread pitch at the threaded circumferential section of the nipple, the spin-on filter and the nipple being mated in threaded engagement.

3. The adapter plate of claim 1 wherein the first face and the second face are oriented in generally parallel arrangement.

4. The adapter plate of claim 1 wherein the exhaust orifice the adapter defines comprises a plurality of exhaust orifices.

5. A method for directing a flow of liquid from a Wm. W. Nugent & Company™ compact filter base and bracket assembly to a spin-on cartridge filter comprises:
providing an adapter plate as described in claim 1;
inserting each of the medial O-ring into the medial channel and the peripheral O-ring into the peripheral channel;
inserting the four bolts to extend through the compact filter base to engage the four threaded bolt holes respectively;
rotating the four bolts each in a clockwise direction to draw the medial O-ring in the medial channel into sealing contact with an aperture boss extending from the base; and the peripheral O-ring in the peripheral channel into sealing contact with a shoulder extending from the base such that there is formed a manifold sealed by the cooperation of the medial O-ring in the medial channel contacting the aperture boss and the perimeter O-ring in the perimeter channel contacting the shoulder.

6. The method of claim 5, further comprising:
providing a spin-on filter cartridge defining a threaded orifice, the threaded orifice having a diameter and thread pitch corresponding to the diameter and the thread pitch at the threaded circumferential section of the nipple, the spin-on filter and the nipple being mated in threaded engagement.

7. The method of claim 5, wherein the first face and the second face are oriented in generally parallel arrangement.

8. The method of claim 5, wherein the exhaust orifice the adapter defines comprises a plurality of exhaust orifices.

9. A method for machining an adapter plate as that described in claim 1, from a material blank having a generally planar first face and a generally planar second face, the method comprising:
routing the first face to define each of a medial channel and a peripheral channel, the medial channel configured to receive a medial O-ring and the peripheral channel configured to receive a peripheral O-ring;
drilling four bolt holes spaced apart to received four bolts to extend from four corresponding holes in the compact filter base
threading each of the four bolt holes such that when a bolt extending through each of the four corresponding holes in the compact filter base is rotated in a clockwise direction the bolts will cooperate to draw the medial O-ring in the medial channel into sealing contact with an aperture boss extending from the base; and the peripheral O-ring in the peripheral channel into sealing contact with a shoulder extending from the base such that there is formed a manifold sealed by the cooperation of the medial O-ring in the medial channel contacting the aperture boss and the perimeter O-ring in the perimeter channel contacting the shoulder; and
drilling an intake orifice through the adapter plate configured to admit a flow of liquid from the first face within the medial O-ring into the cartridge filter;
inserting the nipple having a threaded circumferential section to receive the spin-on cartridge filter, the dimensions of the nipple and the threaded circumferential section being selected to mate with the cartridge filter in a manner that facilitates suitable flow of liquid through the cartridge filter; and
drilling an exhaust orifice to allow a liquid flow from within the cartridge filter to the manifold.

10. The method of claim 9, further comprising:
providing a spin-on filter cartridge defining a threaded orifice, the threaded orifice having a diameter and thread pitch corresponding to the diameter and the thread pitch at the threaded circumferential section of the nipple, the spin-on filter and the nipple being mated in threaded engagement.

11. The method of claim 9, wherein the generally planar first face and the generally planar second face are oriented in generally parallel arrangement.

12. The method of claim 9, wherein drilling the exhaust orifice the adapter defines comprises drilling a plurality of exhaust orifices.
